(19) United States
(12) Patent Application Publication
(10) Pub. No.: US 2004/0111649 A1
(43) Pub. Date: Jun. 10, 2004

(54) Memory device with power-saving mode

(75) Inventors: Jang-Min Lin, Taipei (TW); Chung Chuan Wang, Taipei (TW)

Correspondence Address: QUINTERO LAW OFFICE, 1617 BROADWAY, 3RD FLOOR, SANTA MONICA, CA, 90404, US

(73) Assignee: Comax Semiconductor Inc.

(21) Appl. No.: 10/338,298

(22) Filed: Jan. 8, 2003

(30) Foreign Application Priority Data
Dec. 10, 2002 (TW) 91135711

(51) Int. Cl. G06F 1/32

(52) U.S. Cl. 713/320

(57) ABSTRACT

A memory device with power-saving mode. A memory unit is coupled to an electronic device to access desired data according to an input signal, wherein the electronic device has an operating voltage and the memory unit comprises an input buffer, a decoder, a memory array, an output buffer and a DC voltage generator. A voltage detector is coupled to the electronic device to detect operating voltage. When operating voltage falls below a predetermined value, and outputs a disable signal to turn off the input buffer and the output buffer, or enters a power-saving mode to apply required voltage with low potential to the input buffer, the decoder, the memory array, and the output buffer, thereby saving power.

### BACKGROUND OF THE INVENTION

1. Field of the Invention

The present invention relates in general to a memory device. More particularly, it relates to a memory device with power-saving mode and an electronic device using the same.

2. Description of the Related Art

Generally, electronic devices, for example cell phones, personal digital assistants (PDAs) and the like, need memory devices to store required programs or data, and powers the required programs and data by capacitors or battery. As functions increase, the data and programs stored in the memory may increase. When the battery power of the electronic device is too low and the power consumption is not minimized, the stored data may be lost before a new battery or power supply is applied to the electronic device.

### SUMMARY OF THE INVENTION

Accordingly, an object of the invention is to minimize power consumption to keep the data in the memory when battery power is low.

According to the object of the invention, the memory device with power-saving mode has a memory unit coupled to an electronic device with an operating voltage to access desired data according to an input signal, and a voltage detector coupled to the electronic device. The memory device has an input buffer, a decoder, a memory array, an output buffer, and a DC voltage generator. The DC voltage generator generates required voltage with high potential in normal mode, and voltage with low potential in power-saving mode to apply to the input buffer, the decoder, the memory array, and the output buffer. The voltage detector is coupled to the electronic device to detect operating voltage.

When operating voltage falls below a predetermined value, and outputs a disable signal to turn off the input buffer and the output buffer, or enters a power-saving mode to apply required voltage with low potential to the input buffer, the decoder, the memory array, and the output buffer, thereby saving power.

According to the object of the invention, the electronic device has a main body with an operating voltage and a memory device with power-saving mode as mention above. When operating voltage falls below a predetermined value, and outputs a disable signal to turn off the input buffer and the output buffer, or enters a power-saving mode to apply required voltage with low potential to the input buffer, the decoder, the memory array, and the output buffer, thereby saving power.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram of the memory device with power-saving mode according to the present invention.

FIG. 2 is a diagram of the electronic device having a memory device with power-saving mode according to the present invention.

### DETAILED DESCRIPTION OF THE INVENTION

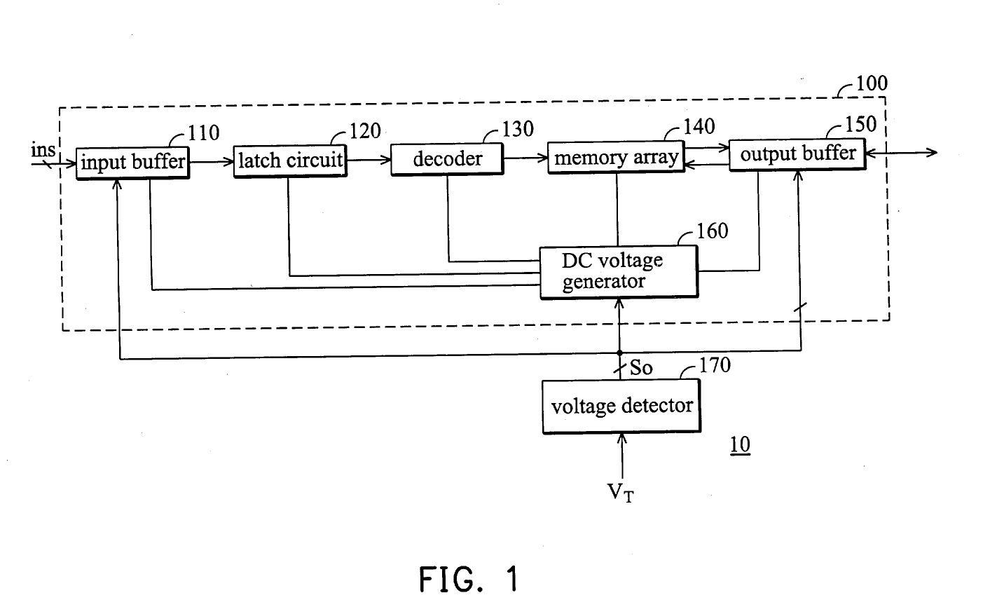

As shown in FIG. 1, a memory device 10 with power-saving mode has a memory unit 100, a voltage detector 170, wherein the memory unit 100 is composed of an input buffer 110, a latch circuit 120, a decoder 130, a memory array 140 and an output buffer 150.

Typically, the memory unit 100 is a dynamic random access memory (DRAM) or static random access memory (SRAM), for example 1T-SRAM, LPSRAM or the like. The memory unit 100 is disposed in an electronic device with an operating voltage (not shown in FIG. 1) to access desired data according to an input signal ins.

In the memory unit 100, the input buffer 110 buffers the input signal ins after receiving it, and the decoder 130 coupled to the input buffer outputs an address signal and a command signal according to the input signal ins. The memory array 140 is coupled to the decoder 130 to access desired data according to the address signal and the command signal from the decoder 130, and the output buffer 150 is coupled to the memory array 140 to buffer the desired data from the memory array 140. The DC voltage generator 160 generates required voltage with high potential to apply to the input buffer 110, the decoder 130, the memory array 140 and the output buffer 150 in normal mode, and voltage with low potential to apply to the input buffer 110, the decoder 130, the memory array 140 and the output buffer 150 in a power-saving mode. In addition, the memory device 10 further has a latch circuit 120 coupled between the input buffer 110 and the decoder 130 to buffer the input signal ins.

The voltage detector 170 is coupled to the input buffer 110, the output buffer 150 and the DC voltage generator 150 to detect operating voltage V_{T} of the electronic device. The voltage detector 170 is a programmable voltage detector with a detection range controlled by an external controller such as a CPU. The voltage detector 170 outputs a disable signal S₀ to turn off the input buffer 110 and the output buffer 150 when operating voltage V_{T} falls below a predetermined value, thereby saving power.

Also, the voltage detector 170 outputs disable signal S₀ to the DC voltage generator 160 such that the DC voltage generator 160 enters the power-saving mode and then outputs required voltage with low potential to the input buffer 110, the decoder 130, the memory array 140 and the output buffer 150, thereby saving power.

As the memory unit 100 is a DRAM with a determined refresh period, the DC voltage generator 160 extends the determined refresh period of the memory unit 100 when operating voltage V_{T} falls below the determined value, thereby saving power.

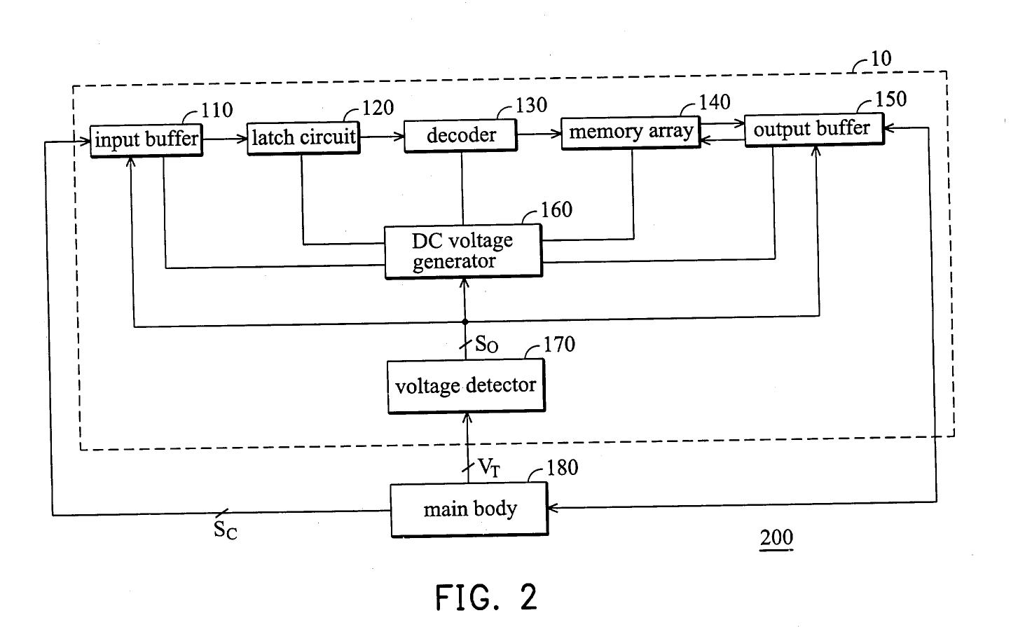

As shown in FIG. 2, the electronic device 200 of the present invention has a main body 180 and a memory device 10 as show in FIG. 1.

The main body 180 with an operating voltage outputs a control signal Sc to access desired data. For example, the main body 180 is a cell phone, a personal digital assistant (PDA) or the like. The main body 180 usually has a microprocessor and other peripheral devices, for example a liquid crystal display, an input pad, a battery and the like (not shown in FIG. 2), wherein the microprocessor executes required programs and processes data, and the battery supplies operating voltage V_{T} to the electric device 200 and other peripheral devices.

The memory device 10 with power-saving mode has a memory unit 100, a voltage detector 170, wherein the memory unit 100 is composed of an input buffer 110, a latch circuit 120, a decoder 130, a memory array 140 and an output buffer 150.

The memory unit 100 is disposed in an electronic device with an operating voltage V_{T} to access desired data according to a control signal Sc.

In the memory unit 100, the input buffer 110 buffers the control signal Sc after receiving the control signal Sc, and the decoder 130 coupled to the input buffer outputs an address signal and a command signal according to the control signal Sc. The memory array 140 is coupled to the decoder 130 to access desired data according to the address signal and the command signal from the decoder 130, and the output buffer 150 is coupled to the memory array 140 to buffer the desired data from the memory array 140. The DC voltage generator 160 generates required voltage with high potential to apply to the input buffer 110, the decoder 130, the memory array 140 and the output buffer 150 in normal mode, and voltage with low potential to apply to the input buffer 110, the decoder 130, the memory array 140 and the output buffer 150 in a power-saving mode.

The voltage detector 170 is coupled to the input buffer 110, the output buffer 150 and the DC voltage generator 150 to detect operating voltage V_{T} of the electronic device. The voltage detector 170 is a programmable voltage detector with a detection range controlled by an external controller such as a CPU. The voltage detector 170 outputs a disable signal S₀ to turn off the input buffer 110 and the output buffer 150 when operating voltage V_{T} falls below a predetermined value, thereby saving power.

Alternately, the voltage detector 170 outputs disable signal S₀ to the DC voltage generator 160 such that the DC voltage generator 160 enters the power-saving mode and then outputs required voltage with low potential to the input buffer 110, the decoder 130, the memory array 140 and the output buffer 150, thereby saving power.

As the memory unit 100 is a DRAM with a determined refresh period, the DC voltage generator 160 extends the determined refresh period of the memory unit 100 when operating voltage V_{T} falls below the determined value, thereby saving power.

Thus, the invention reduces power consumption to keep data in the memory when battery power is low.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A memory device with power-saving mode, comprising:
a memory unit coupled to an electronic device to access desired data according to an input signal, wherein the electronic device has an operating voltage and the memory unit comprises:
an input buffer for buffering the input signal;
a decoder coupled to the input buffer to output a address signal and a command signal according to the input signal;
a memory array coupled to the decoder to read or write the desired data according to the address signal and the command signal;
an output buffer coupled to the memory array to buffer the desired data from the memory array; and
a DC voltage generator for generating required voltage with high potential and required voltage with low potential to apply to the input buffer, the decoder, the memory array and the output buffer; and
a voltage detector coupled to the electronic device to detect operating voltage, and outputting a disable signal to turn off the input buffer and the output buffer when operating voltage falls below a predetermined value.

2. The memory device as claimed in claim 1, wherein the DC voltage generator has a power-saving mode and a normal mode, and outputs required voltage with high potential under the normal mode, and outputs required voltage with low potential under the power-saving mode.

3. The memory device as claimed in claim 2, wherein, when operating voltage falls below a predetermined value, the voltage detector further outputs the disable signal to cause the DC voltage generator to enter the power-saving mode and to output required voltage with low potential.

4. The memory device as claimed in claim 3, wherein the memory device further comprises a latch circuit to latch the input signal.

5. The memory device as claimed in claim 3, wherein the memory unit is a static random access memory (SRAM).

6. The memory device as claimed in claim 3, wherein the memory unit is a dynamic random access memory (DRAM), and has a determined refresh period.

7. The memory device as claimed in claim 6, wherein the DC voltage generator extends the determined refresh period of the memory unit when operating voltage falls below a determined value.

8. The memory device as claimed in claim 6, wherein the voltage detector is a programmable voltage detector.

9. An electronic device having a memory device with power-saving mode, comprising:
a main body having an operating voltage and outputting a control signal to access desired data; and
a memory device with power-saving mode, coupled to the electronic device, wherein the memory device comprises:
an input buffer for buffering the control signal;
a decoder coupled to the input buffer to output a address signal and a command signal according to the control signal;
a memory array coupled to the decoder to read or write the desired data according to the address signal and the command signal;
a DC voltage generator for generating required voltage with high potential and required voltage with low potential to apply to the input buffer, the decoder, the memory array and the output buffer; and
a voltage detector coupled to the electronic device to detect operating voltage, outputting a disable signal to turn off the input buffer and the output buffer when operating voltage falls below a predetermined value.

10. The electronic device as claimed in claim 9, wherein the DC voltage generator has a power-saving mode and a normal mode, and outputs required voltage with high potential under the normal mode, and outputs required voltage with low potential under the power-saving mode.

11. The electronic device as claimed in claim 10, wherein, when operating voltage falls below a predetermined value, the voltage detector further outputs the disable signal to cause the DC voltage generator to enter the power-saving mode and to output required voltage with low potential.

12. The electronic device as claimed in claim 10, wherein the memory device further comprises a latch circuit to latch the input signal.

13. The electronic device as claimed in claim 10, wherein the memory unit is a static random access memory (SRAM).

14. The electronic device as claimed in claim 10, wherein the memory unit is a dynamic random access memory (DRAM), and has a determined refresh period.

15. The electronic device as claimed in claim 14, wherein DC voltage generator extends the determined refresh period of the memory unit when operating voltage falls below a determined value.

16. The electronic device as claimed in claim 12, wherein the main body is a cell phone.

17. The electronic device as claimed in claim 12, wherein the main body is a personal digital assistant (PDA).

18. The electronic device as claimed in claim 12, wherein the voltage detector is a programmable voltage detector.
